(19) United States
(12) Patent Application Publication
(10) Pub. No.: US 2013/0344468 A1
(43) Pub. Date: Dec. 26, 2013

(54) Obtaining Structured Data From Freeform Textual Answers in a Research Poll

(71) Applicants: Robert Taaffe Lindsay, San Francisco, CA (US); Sean Michael Bruich, Palo Alto, CA (US); Frederick Ross Leach, San Francisco, CA (US)

(72) Inventors: Robert Taaffe Lindsay, San Francisco, CA (US); Sean Michael Bruich, Palo Alto, CA (US); Frederick Ross Leach, San Francisco, CA (US)

(21) Appl. No.: 13/533,625

(22) Filed: Jun. 26, 2012

(51) Int. Cl. G09B 19/00

(52) U.S. Cl. 434/322

(57) ABSTRACT

A research polling system obtains structured data from freeform text answers in a research poll. The system includes a database of objects that may represent answers to a research poll. The system presents a research poll to a user, where the research poll includes at least one freeform text field among the answers in the poll. A user answering the poll provides a partial user input to a research poll question in the text field. In response, the system searches for objects in the database that match the user's input, and optionally also based on the question. If one or more matching objects are found, the system presents the matching objects in a listing interface, from which the user may select an object for the answer to the poll question.

### BACKGROUND

This invention generally pertains to research polling, and more specifically to obtaining structured data from freeform text entered via text boxes in a research poll.

When conducting a research poll, multiple choice questions allow respondents to answer a question given a set of possible different answers. The main strength of this type of question is that the form is easy to fill in and the answers can be checked and easily quantified. But multiple choice questions can also bias the results of a poll, since the allowable answers and the way they are worded may not be in line with how someone would naturally answer the question. For this reason, open-ended questions, where a user is free to provide any answer without being prompted by multiple choice, may yield better responses in many circumstances.

A downside of open-ended questions, however, is that they can be very difficult to quantify. One major problem lies in the designing of a numerical way for analyzing and statistically evaluating distinct responses and responses that are differently worded by are intended to mean the same thing. To process multiple choice questions, answer choices are counted and statistics used to analyze the results. But for open-ended questions, answers are sometimes manually mapped to certain numerical values to be judged quantitatively. Computer programs can be designed to pre-process the open-ended responses. However, unstructured data processing is still a challenging task and may cause significant errors. In particular, it can be difficult to disambiguate open-ended answers that should be treated as the same from those that should be treated as distinct.

### SUMMARY

Embodiments of the invention provide a system for obtaining structured data from freeform text answers in a research poll. The system includes a database of objects that may represent answers to a research poll. The system presents a research poll to a user, where the research poll includes at least one freeform text field among the answers in the poll. A user answering the poll provides a partial user input to a research poll question in the text field. In response, the system searches for objects in the database that match the user's text input, and optionally also based on the question. If one or more matching objects are found, the system presents the matching objects in a listing interface, from which the user may select an object for the answer to the poll question. In one embodiment, this process is repeated as the user provides each character of user input, thereby narrowing the matching objects via a prefix query of the database using the user input. Upon selection of an object, the system marks the selected object as the user's answer to the corresponding poll question.

In various embodiments, the matching object is presented as an auto-fill to the partial user input. Alternatively, the matching object may be presented as a list of candidate answers to complete the partial user input. In response to an unsuccessful match, the system may receive a freeform text answer from the user and update the object database with the freeform text answer. The objects in the database may include objects collected from at least one of: input from other users, user profiles, advertisements, product reviews, user comments, and social networking system pages.

In various embodiments, the system ranks the matching objects obtained from the database and orders the matching objects in a list for the user based on the ranking. The system may compute the rankings based on how well the objects fit with a category of the question. For example, if a question asks for a favorite food and the user types “bru” in the text field, the system may rank the matching object associated with the food item “Brussels sprouts” higher than the matching object associated with the city “Brussels.” Alternatively, the system may filter the matching objects based on whether they also match the category, thereby preventing users from selecting irrelevant objects for the answer. The category of the question may be provided by the creator of the research poll, or the category may be learned over time based on other users' answers to the same question.

### BRIEF DESCRIPTION OF THE DRAWINGS

FIG. 1 illustrates an example user interface for receiving a freeform text answer in a research poll, in accordance with an embodiment of the invention.

FIG. 2 is a block diagram of various components of a research poll system, in accordance with an embodiment of the invention.

FIG. 3 is a flowchart of a method for obtaining structured data from freeform textual answers in a research poll, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

An online research poll system offers its customers the ability to collect opinion and feedbacks effectively and affordably than paper forms. People respond to the questions on a number of client devices with their answers, which can be instantly transferred to a poll server for processing. The polling software on the poll server can be easily maintained and updated with great flexibility. Security mechanisms can also be deployed in the polling system to ensure users' privacy.

Embodiments of the invention provide include a research poll system that allows a user to enter freeform text in a text field as an answer to one or more questions in the poll. However, sometimes even if two users give the same answer to a question, they may spell the answer differently, or write the answer in different order. To avoid this ambiguity, the system gathers similar answers that are intended to refer to the same thing and stores a structured answer in a database. This enables the system to provide selections for the users as they type at least a portion of their answer into the text field. For example, to assist users in answering a question about their favorite soda, the system may search the database and display a list of brands that match the text that the user has typed in the text field. Once the user chooses one of the candidates, the answer is complete with a unified spelling and format. At the same time, the users may still have the freedom to ignore the assistance and write their own answers that are not included on the list.

In addition to the interactions with the users, the research poll system can interact with various types of objects supported by the system including but not limited to: user profiles, advertisements, user-generated content (e.g., user posts), events (e.g., a sale that users are interested in), entity hubs (e.g., a particular entity's presence in social networks), etc. The poll system can associate a research question with matched objects from the database based on user's partial input to provide assistance to the user. For example, the poll system can provide a typeahead, i.e., displaying a matched object from the query results in grey letters, as the user types each character. The poll system can also display a list of candidate answers from objects that match the text input mined from other users' answers, user profiles and advertisements. These are just a few examples of the objects that match the text input upon which a user may act on in a research poll system, and many others are possible. An object can also include an item of user generated content. For example, a user may post on a company's fan page. The post can include a user generated comment providing the user's opinion of the company's products. In one embodiment, a research poll system provides a matching object for a sponsored object. For instance, the sponsored object from an advertisement, from a “liked” product page and/or the like.

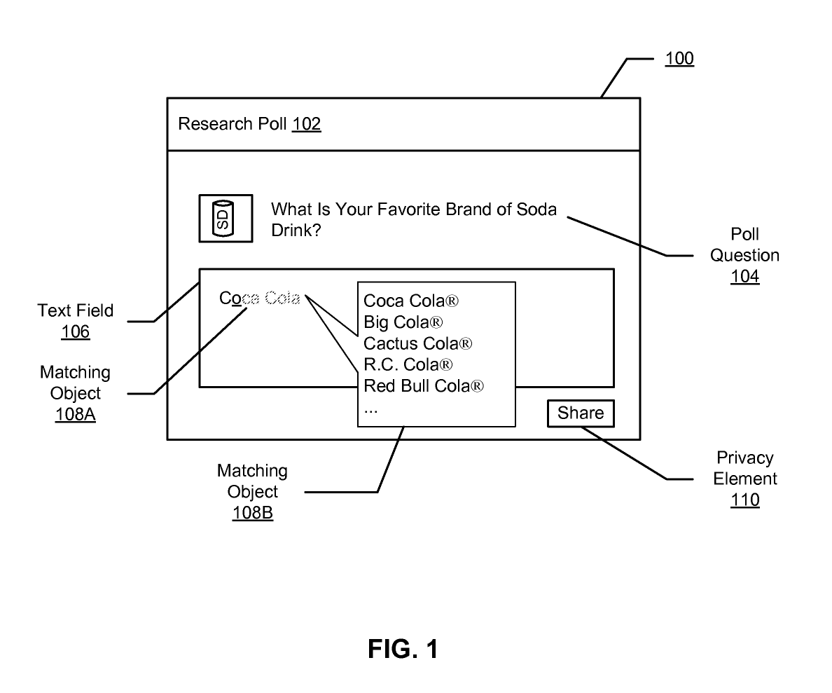

FIG. 1 illustrates an exemplary user interface 100 for a research poll. As shown in FIG. 1, the user interface 100 includes a poll title 102, a question 104, a text field 106, matching object 108A and 108B, and a privacy element 110. In the research poll 102, users are asked to answer the open-ended poll question 104 “What is your favorite brand of soda drink?” The text field 106 allows users to type whatever answers they feel like to. For example, a user may start his or her answer with “My favorite soda drink is . . . ” while other users can simply put a single word of the brand of the soda drink as the answer.

In FIG. 1, there is showing a user typed answer starting with “Co” in the text field 106. The text field 106 also includes an auto-filled text 108A that completes the answer “Coca Cola®”. There is a further matching object 108B that displays a list of candidates of soda brands for users to choose from. The matching objects 108A and 108B can be displayed simultaneously or separately depending on the configuration of the user interface 100. Unlike multiple-choice poll questions, the matching object does not limit the scope of user answers, but simply assists users with the format of popular answers. For example, some users may type “Coke”, “Coca-Cola”, or “coca cola” instead of “Coca Cola®”. The matching objects 108A and 108B help normalize the answer formats and potentially simplify the processing of the research poll. The users may still ignore the assistance and type their own answers that are not suggested by the matching objects 108A and 108B.

The user interface 100 may also include a privacy element 110. The privacy element enables poll users to limit the use of their interaction with and/or information provided via the text field 106. For example, a user can indicate that his or her answer to the question 104 not be shared with others. On the other hand, if the user decides to share his or her favorite drink choice, the research poll environment can interface with social networks to add the information to his or her public profile, review and fan page of the specific product, and group of users sharing the same choice.

### System Architecture

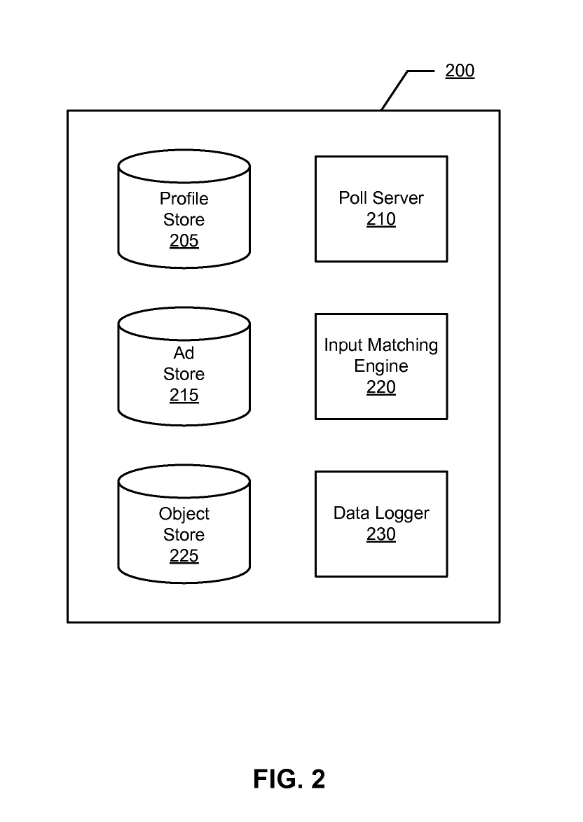

FIG. 2 is an example block diagram of various components of the research poll system 200. The research poll system 200 includes a poll server 210, a data logger 230, an input matching engine 220, a profile store 205, an ad store 215, and an object store 225. In alternative configurations, different components can be included in the system 200.

In general, the poll server 210 links the research poll system 200 via networks to one or more of the clients and users to conduct online poll, collect answers, and generate poll reports. The poll server 210 can optionally connect to one or more third party websites that launch and manage market research polls to design, generate and collect questionnaire, as well as to analyze poll results. During the polls, the poll server 210 communicates with various data stores, such as the profile 205, the ad store 215, and the object store 225, which store data structures corresponding to their respective objects maintained by the poll system 200. For example, the profile store 205 contains data structures for describing users' profiles, such as demographical information for personal users, or product and brand information for business users. Similarly, the ad store 215 maintains data related to advertisements, such as advertisers, product specifications, campaign plans, advertisement contents, and targeting users.

Before conducting the research poll, the poll server 210 can assist in selecting groups of user for the poll. For example, a market research may require a control group of users that has been exposed to promotional sales. This group of users can be identified from those following in the previous sale events from the ad store 215. By querying user profiles from the profile store 205, the poll server 210 can also identify users based on demographical data, such as gender, race, age, employment, hobby, and location, among other information. Alternatively, users can also be categorized according to their interest level in the poll product. To estimate a user's interest in a particular product, for example, the poll server 210 can retrieve data from the profile store 205 and the ad store 215 to compute a weighted sum of the user's affinities with the product including the user's review, comments, interactions with friends and “like” status regarding similar products and associated advertisements.

The input matching engine 220 searches for objects that match the user input received by the poll server 210. In one embodiment, the input matching engine 220 first determines whether a previous search for the research question has been performed. If so, the input matching engine 220 retrieves matching objects from the previous search result. Otherwise, a new matching object search is performed by the input matching engine 220. Since the user input may be partially typed answers to a research question, the input matching engine 220 can retrieves a number of objects that match the partially type input and keywords in the research question from the object store 225. The candidate objects can also be retrieved from previously received ad in the ad store 215 for similar products and brands from advertisers, advertising brokers, and/or the like. Alternatively, the input matching engine 220 can search profile store for competitors, user reviews, recommendations, fans, similar business, “like” items for objects that match the text input to the user input.

Once objects that match the text input are retrieved, the input matching engine 220 selects the candidate objects to present to the user. In one embodiment, the input matching engine 220 filters or ranks the matched objects from the object store 225. The filtering and ranking of the matching objects can be computed based on a number of criteria, for instance, the closeness a matching object fits with a category associated with the poll questions. As an example, in the user interface 100 in FIG. 1, the matching object 108A and 108B are candidates selected from objects associated with the “soda drink” category.

In one embodiment, poll questions can be categorized manually by the party that designs, manages, or sponsors the questionnaire. For example, poll question 104 “What is your favorite brand of soda drink?” in FIG. 1 is part of a poll on soda drink brands, thus can be associated with a “soda drink” category by design. Based on this category, the matching objects 108A and 108B are filtered from the objects associated with the questions in the same category stored in the object store 225. Moreover, the matching object can be ranked based on how many letters are matched to the user input, and/or the position of the matched letters in the matching object.

Alternatively, poll questions can be categorized automatically by the poll server 210 through semantic analysis and machine learning. The semantic analysis analyzes relationships among a set of poll questions and terms included in the poll questions to produce a set of categories. Objects mined from the profile store 205 and ad store 215, as well as new poll questions and user answers can be input to a supervised or unsupervised learning algorithm to augment the categories and associated questions and objects. Note that as a result of the semantic analysis and learning, a poll question may be associated with multiple categories. For example, the poll question 104 may be categorized under “soda drink” and “favorite brand.”

After selecting the candidate objects to present, the input matching engine 220 transfers the candidate objects to the poll server 210, which displays the candidate objects on the poll user interface. In one embodiment, the candidate objects can be paired with the research question. As a result, the input matching engine 220 can retrieve the candidate objects associated with the question and questions in the same category.

The data logger 230 is capable of storing user answers to the research questions so that the poll server can process the data and report poll results after the research poll is finished. The data logger can also store all the objects in the matching object search results associated with the research questions and the question categories. The data logger monitors communications at the poll server 210 regarding different interactions users may have with different types of research poll objects in the research poll system 200. The data logger 230 can maintain such data in any suitable manner. In one embodiment, each of the profile store 205, the ad store 215, and the object store 225, stores data structures to manage the data for each instance of a corresponding type of research poll object maintained by the system 200. The data structures include information fields that are suitable for the corresponding type of object. For example, the ad store 215 contains data structures that include the product descriptions, target audiences, and expiration time for an advertisement, whereas the profile store 205 contains data structures with fields suitable for describing a user's profile. When a new object of a particular type is created, the data logger 230 initializes a new data structure of the corresponding type, assigns a unique object identifier to it, and begins to add data to the object as needed. This might occur, for example, when a new matching object search is received, and input matching engine 220 collects a new group of objects that match the text input in response to a research question, ranks the candidate objects, and selects the top ranked objects.

In one embodiment, the data logger 230 further processes user answers to the research questions to discover candidate objects. If certain freeform answers occur at a number greater than a predetermined threshold, the data logger 230 adds the freeform answers to the object store 225 as new candidate objects for the corresponding research questions and the question categories. The threshold can be defined using either absolute (e.g., five occurrences) or relative (e.g., 5% of the freeform answers) number of occurrence. For example, in FIG. 1, if more than five users type in answer of “Coke”, the data logger 230 may be configured to add the “Coke” as a matching candidate object and present in the matching object 108B for later users.

### Method for Obtaining Structured Answers

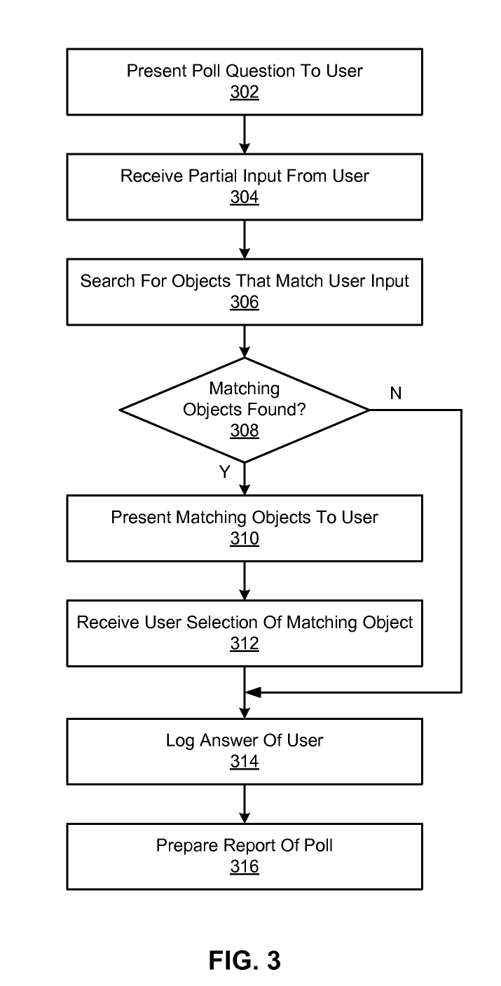

FIG. 3 illustrates one embodiment of a method for obtaining structured data from freeform textual answers in a research poll. In the embodiment, the system presents 302 a pool question to each of a plurality of users. The poll question comprises an answer field for receiving text input from the user. For one or more of the plurality of users, the system receives 304 a partial input from the user via the answer field. For example, the poll question is research poll on certain products and allows user to openly fill in brand, type, or any characteristics of the product. The partial user input is then searched 306 in an object database for matching objects. If one or more matching objects are found 308, the one or more matching objects are presented 310 to the user as candidate answers. The user can then select 312 from the presented list of candidate answers to provide the answer to the question. The system logs 314 the selected candidate answer as the user's response to the poll question. After all the users finish the poll, the system prepares 316 a report summarizing the users' responses to the poll question based on the logging. In one embodiment, if no matching objects are found, the user's freeform text input is logged instead as the answer to the poll question.

In one embodiment, objects that match the text input can be searched and matched by the input matching engine 220 from the object store 225, as described above with reference to FIG. 2. The matching object can be presented to the user in auto-filled text 108A or a list of candidates 108B, as described above with reference to FIG. 1. Next, the system stores 310 the user's answers. After all the data is collected, the system processes 312 the poll data and reports 314 the poll results. For example, the data logger 230 collects the user's answers for the poll, and/or save the answers to the user profile in profile store 205, as described above with reference to FIG. 2.

In one embodiment, the system processes the poll data by aggregating the answers that select the same matching object. Since the matching object normalizes the answer formats, the processing of the research poll is significantly simplified. For example, potential user inputs to answer the poll question 104, such as of “Coke”, “Coca-Cola”, or “coca cola” are normalized to a standard answer “Coca Cola®” by the matching object 108A. Aggregating users who select the answer “Coca Cola®” can be implemented by an exact string comparison, which introduces no false positive or false negative. In addition, the report of the poll result can also include free text when users do not select any matching object. These freeform text answers may be processed and stored in the object store 225.

### Additional Considerations

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may include a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
presenting a poll question to a user, the poll question comprising an answer field for receiving text input from the user;
receiving a partial input from the user via the answer field;
searching for one or more candidate answers that match the user's partial input;
presenting the one or more candidate answers that match the user's partial input;
receiving a selection from the user of one of the candidate answers; and
logging the selected candidate answer as the user's response to the poll question.

2. The method of claim 1, wherein searching for candidate answers comprises:
determining a category associated with the poll question; and
filtering the candidate answers matching the partial user input based on the determined category.

3. The method of claim 2, wherein determining the category associated with the poll question comprises receiving the category from a creator of the poll.

4. The method of claim 2, wherein determining the category associated with the poll question comprises performing semantic analysis at least on the poll question and other users' answers to the question.

5. The method of claim 2, wherein the candidate answers are structured objects collected from at least one of: input from other users, user profiles, advertisements, product reviews, user comments, and social network pages and communications.

6. The method of claim 1, further comprising:
in response to a successful search, presenting the candidate answers in at least one of:
an auto-fill to the partial user input; and
a list of candidates.

7. The method of claim 1, further comprising:
receiving user answers to the poll question, wherein the user answers include a selection from the candidate answers or a freeform text input by the user.

8. The method of claim 7, further comprising:
determining a number of occurrence for a freeform answer to the poll question; and
in response to the number of occurrence exceeding a predetermined threshold, storing the freeform answer as a candidate answer to the poll questions.

9. The method of claim 1, further comprising:
collecting user answers to the poll question; and
reporting poll results based on the collected user answers.

10. The method of claim 9, wherein reporting poll results comprises aggregating the user selections of the same candidate answers.

11. A method comprising:
presenting a poll question to each of a plurality of users, the poll question comprising an answer field for receiving text input from the user;
for one or more of the plurality of the users,
receiving a partial input from the user via the answer field,
searching for one or more candidate answers that match the user's partial input,
presenting the one or more candidate answers that match the user's partial input,
receiving a selection from the user of one of the candidate answers, and
logging the selected candidate answer as the user's response to the poll question; and
preparing a report summarizing the users' responses to the poll question based on the logging.

12. A non-transitory computer-readable storage medium storing executable computer program instructions for obtaining structured data from freeform text answers in a research poll, the computer program instructions comprising instructions for:
presenting a poll question to a user, the poll question comprising an answer field for receiving text input from the user;
receiving a partial input from the user via the answer field;
searching for one or more candidate answers that match the user's partial input;
presenting the one or more candidate answers that match the user's partial input;
receiving a selection from the user of one of the candidate answers; and
logging the selected candidate answer as the user's response to the poll question.

13. The storage medium of claim 11, wherein searching for candidate answers comprises:
determining a category associated with the poll question; and
filtering the candidate answers matching the partial user input based on the determined category.

14. The storage medium of claim 12, wherein determining the category associated with the poll question comprises receiving the category from a creator of the poll.

15. The storage medium of claim 12, wherein determining the category associated with the poll question comprises performing semantic analysis at least on the poll question and other users' answers to the question.

16. The storage medium of claim 12, wherein the candidate answers are structured objects collected from at least one of: input from other users, user profiles, advertisements, product reviews, user comments, and social network pages and communications.

17. The storage medium of claim 11, wherein the computer program instructions further comprise instructions for:
in response to a successful search, presenting the candidate answers in at least one of:
an auto-fill to the partial user input; and
a list of candidates.

18. The storage medium of claim 11, wherein the computer program instructions further comprise instructions for:
receiving user answers to the poll question, wherein the user answers include a selection from the candidate answer or a freeform text input by the user.

19. The storage medium of claim 18, wherein the computer program instructions further comprise instructions for:
determining a number of occurrence for a freeform answer to the poll question; and
in response to the number of occurrence exceeding a predetermined threshold, storing the freeform answer as a candidate answer to the poll questions.

20. The storage medium of claim 11, wherein the computer program instructions further comprise instructions for:
collecting user answers to the poll question; and
reporting poll results based on the collected user answers.

21. The storage medium of claim 18, wherein reporting poll results comprises aggregating the user selections of the same candidate answers.

22. A non-transitory computer-readable storage medium storing executable computer program instructions for obtaining structured data from freeform text answers in a research poll, the computer program instructions comprising instructions for:
presenting a poll question to each of a plurality of users, the poll question comprising an answer field for receiving text input from the user;
for one or more of a plurality of the users,
receiving a partial input from the user via the answer field,
searching for one or more candidate answers that match the user's partial input,
presenting the one or more candidate answers that match the user's partial input,
receiving a selection from the user of one of the candidate answers, and
logging the selected candidate answer as the user's response to the poll question; and
preparing a report summarizing the users' responses to the poll question based on the logging.
